(19) United States
(12) Patent Application Publication
(10) Pub. No.: US 2005/0160995 A1
(43) Pub. Date: Jul. 28, 2005

(54) Endless water bowl

(76) Inventor: James Winslow Graves JR., Arvada, CO (US)

Correspondence Address: JAMES W. GRAVES JR., 8447 DOVER CT., ARVADA, CO, 80005, US

(21) Appl. No.: 10/367,019

(22) Filed: Sep. 2, 2003

(51) Int. Cl. A01K 7/04

(52) U.S. Cl. 119/78

(57) ABSTRACT

This invention, (The Endless water bowl) hooks up to a constant fresh water supply that feeds into a watering bowl, via a supply line with tap valve. The water supply is controlled by a plastic float valve at the back of the bowl. The supply line is hooked into a copper line with the afore-mentioned tap valve. This will provide a self controlled, infinite fresh water supply.

My invention is called the “Endless water bowl”. The “Endless water bowl will provide an endless fresh water supply for any animal at all times of the day or night.

### DESCRIPTION OF THE INVENTION

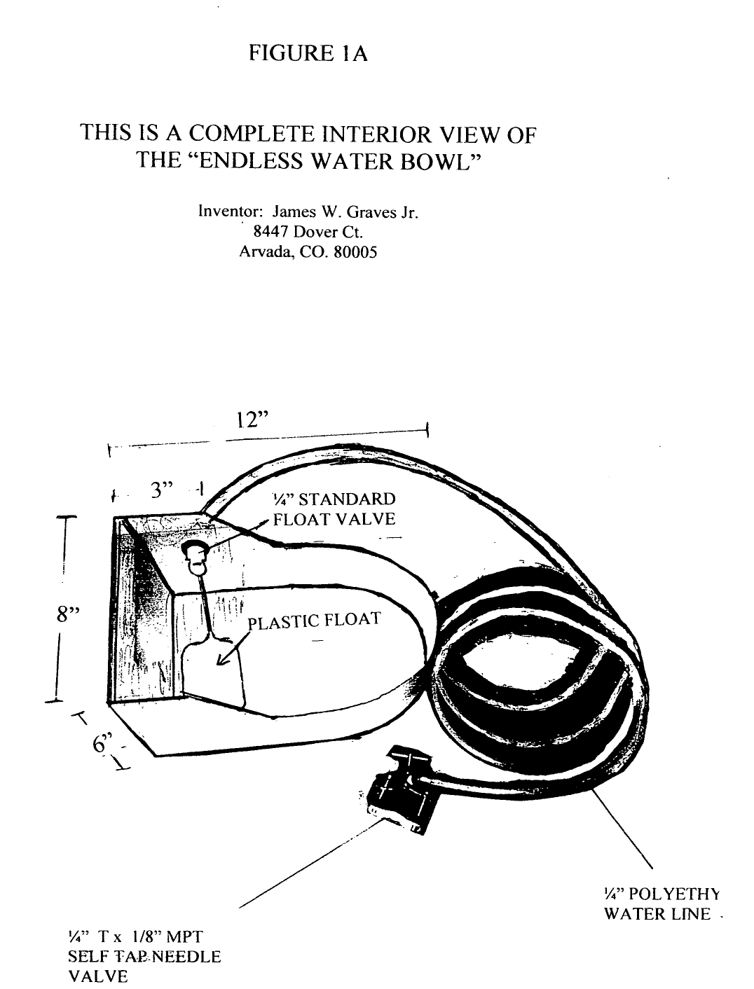

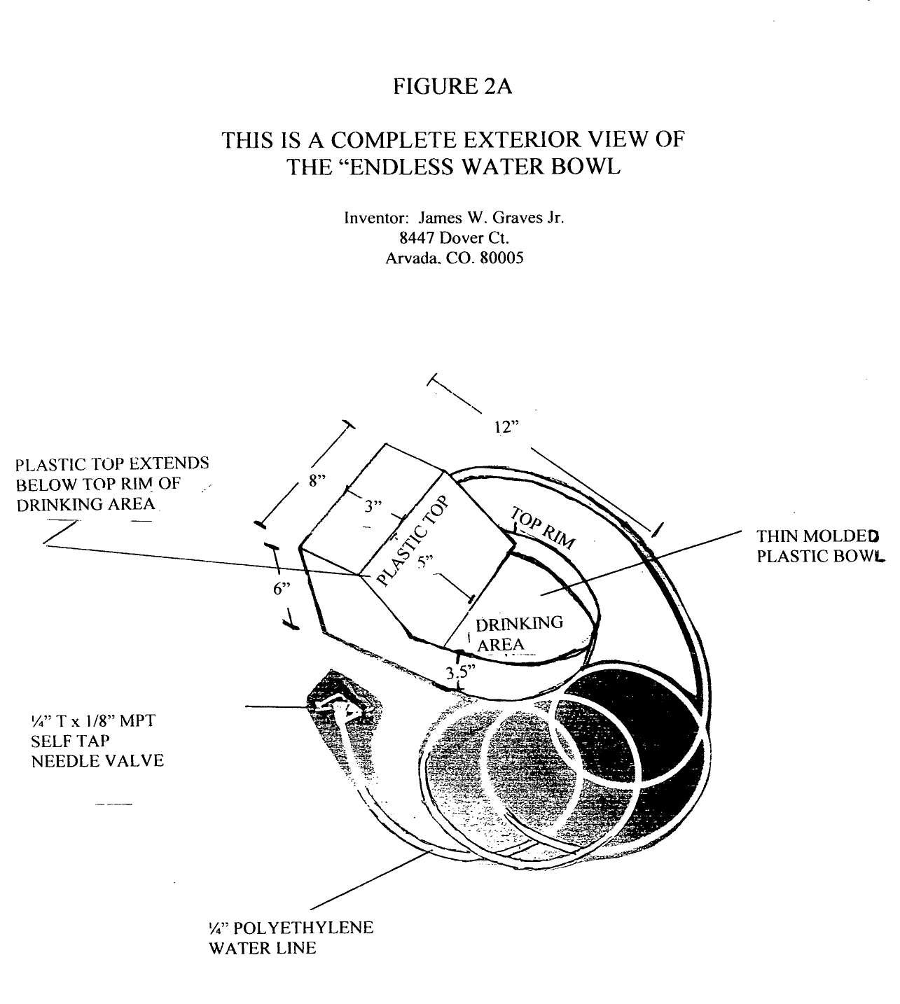

The “Endless water bowl” is a water bowl for all animals that provides an infinite fresh water source. The bowl is made of thin molded plastic, approximately 8 inches wide, 12 inches long, 6 inches tall in the back, and 3½ inches tall in the front. (See FIGS. 1A and 2A.) There is a ¼ inch standard float valve approximately 3¾ inches up from the bottom, and 2¾ inches in from the back of the bowl. (See FIGS. 1A and 2A.) The float valve is connected to a 10 ft. by 1/4 inch polyethylene water line. The opposite end is connected to a ¼ T inch×⅛ MPT inch self tapping needle valve. (See FIGS. 1A and 2A.) The needle valve will be connected to a ½ inch copper water line.

### BACKGROUND OF INVENTION

This invention, the “Endless water bowl” will alleviate the problem of supplying fresh water to animals on a constant basis. There appears to be no other inventions that show any similar solutions. I, James W. Graves Jr. have had pets for many years, and this bowl is the solution to having to constantly refill the water.

1. What I. James W. Graves Jr. Claim as my invention is a solution from having to worry if an animal has enough water. The “Endless water bowl” provides an infinite fresh water source to any animal. This device is internally controlled, which will alleviate any maintenance. The water supply is continuous.
